(19) United States
(12) Patent Application Publication
(10) Pub. No.: US 2026/0295335 A1
(43) Pub. Date: Oct. 1, 2026

(54) GOLF COURSE GOLF BALL TRACKING SYSTEM

(71) Applicant: Textron Inc., Providence, RI (US)

(72) Inventors: Payton Loppnow, Augusta, GA (US); Haley Lind, Payton, SC (US)

(73) Assignee: Textron Inc., Providence, RI (US)

(21) Appl. No.: 19/096,665

(22) Filed: Mar. 31, 2025

(51) Int. Cl. A63B 24/00; A63B 69/36; A63B 71/06; B60W 50/14

(52) U.S. Cl. CPC A63B 24/0021; A63B 69/3605; A63B 71/0622; B60W 50/14; A63B 2024/0034; A63B 2024/0053; A63B 2220/12; A63B 2225/20; A63B 2225/50; B60W 2050/146; B60W 2300/405

(57) ABSTRACT

A golf course system includes one or more processing circuits configured to acquire one or more signals from a communication device of a golf ball and provide an indication on a display device associated with a golfer regarding a position of the golf ball on a respective hole of the golf course following a golf stroke of the golfer based on the one or more signals.

### BACKGROUND

Golf vehicles are used to transport personnel and equipment between different areas. By way of example, a golf vehicle may transport golfers and equipment (e.g., golf bags, golf clubs, etc.) around a golf course (e.g., along a cart path, between different holes, etc.). Golfers frequently hit golf balls on a golf course.

### SUMMARY

One embodiment relates to a golf course system. The golf course system includes one or more processing circuits. The one or more processing circuits are configured to acquire one or more signals from a communication device of a golf ball and provide an indication on a display device associated with a golfer regarding a position of the golf ball on a respective hole of the golf course following a golf stroke of the golfer based on the one or more signals.

Another embodiment relates to a golf course system. The golf course system includes a golf ball including a communication device, a golf cart including one or more sensors configured to acquire one or more signals from the communication device of the golf ball, and one or more processing circuits configured to: track a trajectory of the golf ball for a portion of a flight path of the golf ball based on the one or more sensors, acquire cart location data regarding a cart location of the golf cart, provide an estimated ball location for where the golf ball lands based on the trajectory and the cart location data, detect the golf ball when within a communication range of the one or more sensors, and provide an actual location of the golf ball relative to the golf cart based on the detection of the golf ball.

Still another embodiment relates to a golf vehicle system. The golf vehicle system includes a plurality of sensors configured to acquire signals from communication devices of golf balls on a golf course, the plurality of sensors configured to be installed at least one of (a) on golf carts or (b) about the golf course, one or more processing circuits configured to acquire shot data regarding the golf ball based on the one or more sensors, aggregate the shot data, calculate shot parameters based on the shot data, and display the shot parameters on the display device. A golf course system may acquire one or more signals from a communication device of a golf ball. A golf course system may provide an indication on a display device associated with a golfer regarding a position of the golf ball on a respective hole of the golf course following a golf stroke of the golfer based on the one or more signals.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is another schematic block diagram of the vehicle of FIG. 1, according to an exemplary embodiment.

FIG. 4 is a schematic block diagram of a site monitoring and control system including a plurality of the vehicles of FIG. 1, according to an exemplary embodiment.

FIG. 5 is a perspective view of a golf ball assembly, according to an exemplary embodiment.

FIG. 6 is a top view of a golf course including the vehicle of FIG. 1, according to an exemplary embodiment.

FIG. 7 is a block diagram of a method for detecting golf ball position, according to an exemplary embodiment.

FIG. 8 is a block diagram of a method for real-time tracking, according to an exemplary embodiment.

FIG. 9 is a block diagram of a method for calculating shot parameters, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

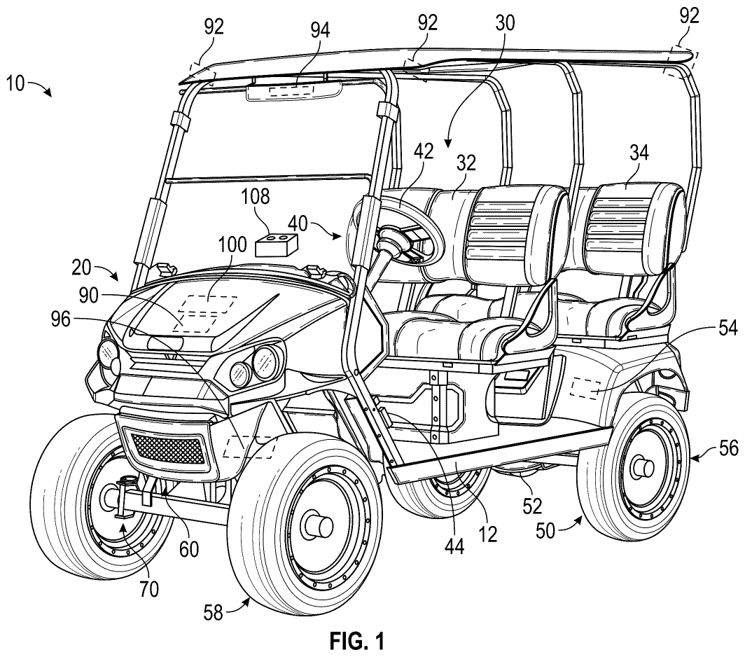

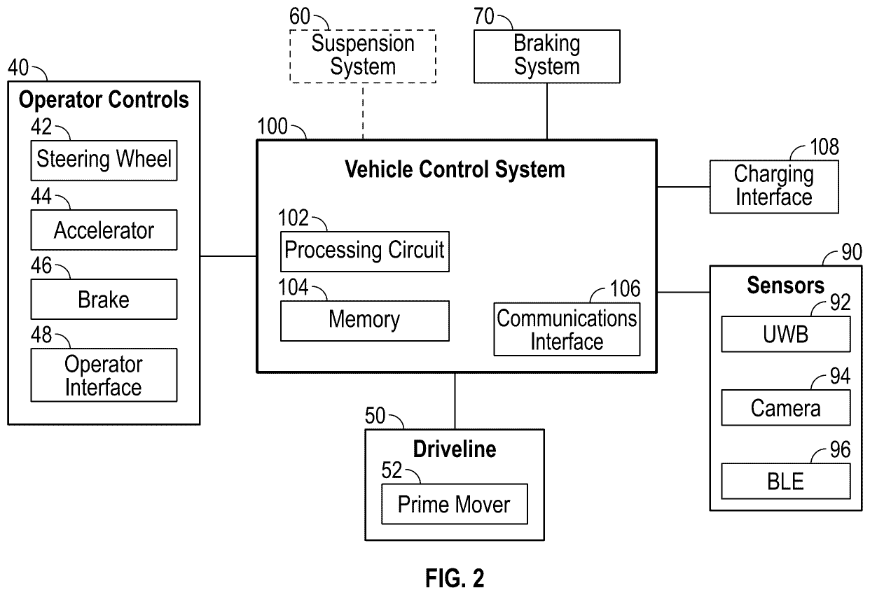

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; a charging interface, shown as ball charger 108; and a control system, shown as vehicle control system 100, coupled to the operator controls 40, the driveline 50, the suspension system 60, the braking system 70, the sensors 90, and the ball charger 108. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart or vehicle, an all-terrain vehicle (“ATV”), a utility task vehicle (“UTV”), a low speed vehicle (“LSV”), a personal transport vehicle (“PTV”), a hauler, a ground support equipment (“GSE”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as user portal 48. The user portal 48 may include one or more displays and one or more input devices. The one or more displays may be or include a touchscreen, a LCD display, a LED display, a speedometer, gauges, warning lights, etc. The one or more input devices may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor (e.g., the motor 53) and the energy storage 54 is a battery system (e.g., the battery module 57, the add-on battery module(s) 59, etc.). In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, electric regenerative braking is employed (e.g., via the prime mover 52, an electric motor, etc.) in combination with or instead of using the braking system 70 to facilitate braking of one or more components of the driveline 50.

As shown in FIG. 1, the ball charger 108 is positioned along a dash of the vehicle 10. In other embodiments, the ball charger 108 is otherwise positioned on the vehicle 10. According to an exemplary embodiment, the ball charger 108 is electrically coupled to the battery module 57. The ball charger 108 is configured to transfer electrical energy to a golf ball (e.g., between the battery module 57 and the battery 154 of the golf ball). In some embodiments, the ball charger 108 transfers energy wirelessly. In such embodiments, the ball charger 108 may include a wireless energy transfer coil to transfer energy through induction. In some embodiments, the ball charger 108 is configured to transfer electrical energy through a physical connection. In such embodiments, the ball charger 108 may include a set of electrical contacts positioned to engage a set of external electrical contacts on the golf ball.

As shown in FIGS. 1 and 2, the sensors 90 include one or more first sensors, including an ultra-wide band sensor (“UWB”) 92, a camera 94, and a Bluetooth low energy (“BLE”) sensor 96 positioned about the vehicle 10 to acquire vehicle information or vehicle data regarding operation of the vehicle 10 and/or the location thereof. The sensors 90 may be positioned along a front, rear, side, top and/or bottom side of the vehicle 10. The sensors 90 may be coupled to one or more components of the vehicle 10. The sensors 90 may additionally or alternatively include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, a Doppler sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the user portal 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Electrified Driveline

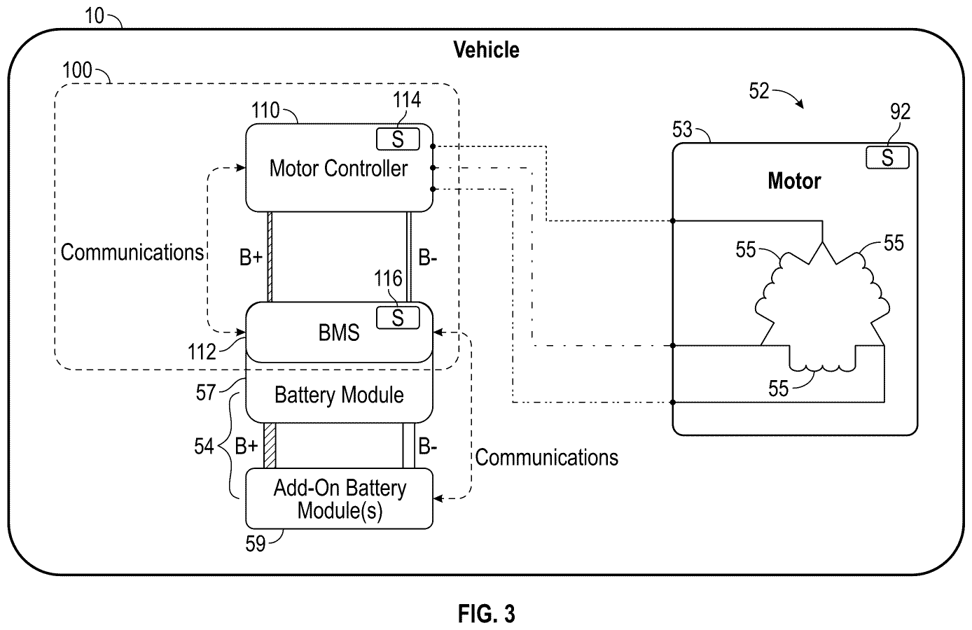

According to the exemplary embodiments shown in FIG. 3, the driveline 50 of the vehicle 10 is configured as an electrified driveline where (a) the prime mover 52 is configured as a three-phase, alternating current (“AC”) electric motor, shown as motor 53, including three sets of windings, shown as motor windings 55, and a first sensor, shown as motor sensor 92; (b) the energy storage 54 is configured as a battery system including a first battery pack or module, shown as battery module 57, and one or more second battery packs or modules, shown as add-on battery module(s) 59, electrically coupled to the battery module 57 in parallel; and (c) the vehicle control system 100 includes (i) a first controller, shown as motor controller 110, coupled to the motor 53 and including a second sensor, shown as motor controller sensor 114, and (ii) a second controller, shown as battery management system (“BMS”) 112, coupled to the motor controller 110 and the energy storage 54 (e.g., the battery system, the battery module 57, the add-on battery module(s) 59, etc.) and including a third sensor, shown as BMS sensor 116. In some embodiments, the motor 53 is configured as a separately excited DC motor. The motor sensor 92, the motor controller sensor 114, and/or the BMS sensor 116 may include a temperature sensor, a voltage sensor, a current sensor, a speed sensor, and/or another suitable sensor to facilitate monitoring at least one of the operational parameters (e.g., temperature, voltage, current, speed, SOC, rate of charge, rate of discharge, etc.) of the motor 53, the motor controller 110, the BMS 112, the battery module 57, and/or the add-on battery modules(s) 59. The motor controller 110 and the BMS 112 may each include a processing circuit 102, a memory 104, and a communications interface 106.

According to an exemplary embodiment, each of the battery module 57 and the add-on battery module(s) 59 of the battery system includes one or more rows and/or groups of battery cells. The BMS 112 may be configured to monitor characteristics of the rows and/or groups of battery cells and/or individual cells of the battery module 57 and the add-on battery module(s) 59 (e.g., using data acquired by the BMS sensor 116) including, but not limited to, voltage, temperature, current, and state of charge (“SOC”). The BMS 112 may also be configured to provide direct current (“DC”) power from the battery system to the motor controller 110 to power the motor 53 based on driving demands of the vehicle 10.

According to an exemplary embodiment, the motor controller 110 is configured to manage the power supplied to the motor 53. By way of example, the motor controller 110 may be configured to modulate the voltage, current, phase, and/or frequency of the power sent to the motor windings 55, which can influence the torque and speed output provided by the motor 53. In some embodiments, the motor controller 110 is configured to control a type of power, AC power or DC power, delivered to the motor 53. By way of example, the motor controller 110 may be configured to convert the type of power from DC power to AC power and/or regulate the AC power or DC power depending on the intended function of the motor 53. The motor controller 110 may include components to invert, convert, or otherwise modulate DC power and/or AC power.

As shown in FIG. 3, the energy storage 54 is configured to supply (e.g., via electrical wiring, electrical connections, etc.) DC power to the motor controller 110. In some embodiments, the DC power flows from the energy storage 54, through the BMS 112, and to the motor controller 110. The BMS 112 and the motor controller 110 may include communication interfaces (e.g., communications interfaces 106) that facilitate exchanging data related to operational status, command signals, and feedback therebetween. The BMS 112 and the add-on battery module 59 (e.g., a BMS thereof) may include communication interfaces that facilitate exchanging data related to operational status, command signals, and feedback therebetween. The add-on battery module(s) 59 is(are) configured to provide additional battery cells and increase the total energy storage capacity of the energy storage 54. As shown in FIG. 3, the battery module 57 and the add-on battery module(s) 59 are connected in parallel (e.g., via wires, connection busses, etc.) to provide for a pathway of electrical transfer. In other embodiments, the battery module 57 and the add-on battery module(s) 59 are connected in series.

According to an exemplary embodiment, the BMS 112 is configured to monitor (e.g., continuously, periodically, etc.) various parameters of the energy storage 54, including voltage, current, and temperature of each cell, rows/groups, and/or module within the energy storage 54. In some embodiments, the BMS 112 is configured to calculate or otherwise determine the SOC of the energy storage 54, the battery module 57, and/or the add-on battery module(s) 59. In some embodiments, the BMS 112 is configured to redistribute charge among the cells, rows/groups, and/or the modules to ensure an equal or substantially equal charge level throughout the energy storage 54. The BMS 112 can communicate with other systems or components or the vehicle 10 or with external devices (e.g., the remote systems 240) to report on battery status and diagnostics and/or to receive control commands.

According to an exemplary embodiment, the BMS 112 is configured to detect faults or failures in the energy storage 54 that may potentially lead to or that have caused an overcharge condition and, thereby, a thermal runaway event. By way of example, the BMS 112 may be configured to monitor the voltage of individual cells, rows/groups, or modules of the energy storage 54, and when deviations from normal voltage levels occur beyond a nominal range, the BMS 112 may determine that a fault or failure is present and that there is a potential for an overcharge condition or that there is an actual overcharge condition. In some implementations, the BMS 112 is configured to detect voltage imbalance or voltage imbalance trends. By way of another example, the BMS 112 may additionally or alternatively be configured to monitor current flows during charging and discharging of the energy storage 54 and identify unexpected fluctuations in current that may indicate that a fault or failure is present and that there is a potential for an overcharge condition or that there is an actual overcharge condition. By way of still another example, the BMS 112 may additionally or alternatively be configured to monitor the temperature of the cells, rows/groups, and/or modules of the energy storage 54 and identify anomalously high temperatures that may indicate that a fault or failure is present and that there is a potential for an overcharge condition or that there is an actual overcharge condition. It should be understood that the above example of detecting faults, failures, or overcharge conditions is provided for example purposes only and is not exhaustive. Other methods or techniques may be implemented to detect faults, failures, or overcharge conditions, which are intended to be included within the scope of the present disclosure. Additional details regarding fault detection regarding the energy storage 54 is described in greater detail herein. Further details regarding fault detection, including voltage imbalance, may be found in U.S. patent application Ser. No. 18/884,363, filed Sep. 13, 2024, which is incorporated herein by reference in its entirety.

### Monitoring and Control System

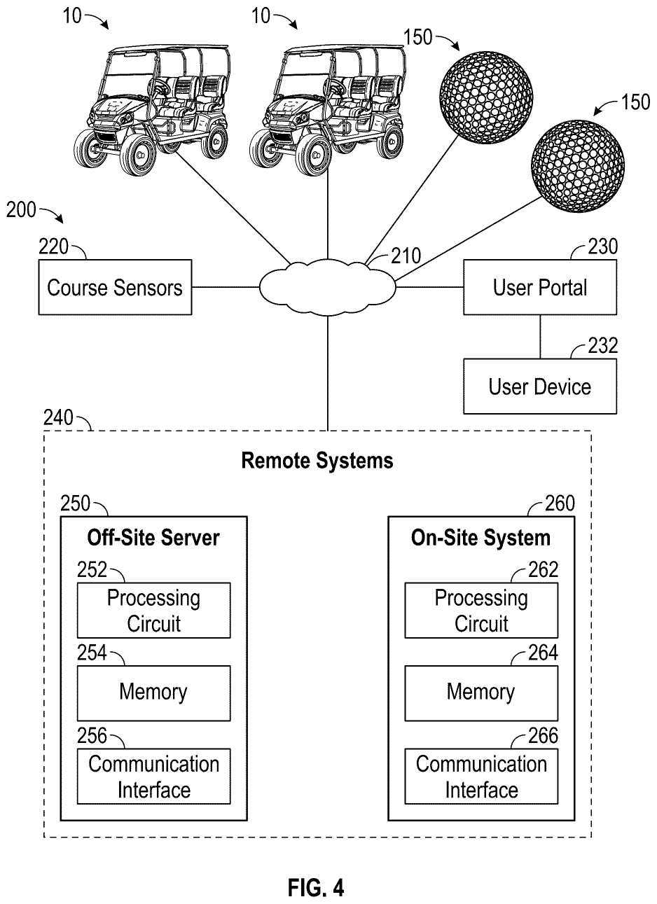

As shown in FIG. 4, a monitoring and control system, shown as site monitoring and control system 200, includes one or more vehicles 10; one or more golf balls 150; one or more second sensors, shown as course sensors 220, positioned remote or separate from the vehicles 10; an user portal, shown as user portal 230, positioned remote or separate from the vehicles 10; an external or remote user device, shown as user device 232, positioned remote or separate from the vehicles 10; and one or more external processing systems, shown as remote systems 240, positioned remote or separate from the vehicles 10. The vehicles 10, the course sensors 220, the user portal 230, and the remote systems 240 communicate via one or more communications protocols (e.g., Bluetooth, Wi-Fi, cellular, radio, through the Internet, etc.) through a network, shown as communications network 210. In some embodiments, the site monitoring and control system 200 does not includes the user portal 230 and/or the user device 232.

The course sensors 220 may be or include one or more sensors that are positioned throughout the golf course 312. By way of example, the course sensors 220 may be or include a devices (e.g., a radio frequency identification (“RFID”) readers, near field communication (“NFC”) readers, Bluetooth Low-Energy (“BLE”) enabled devices, UWB readers, cameras, etc.) that facilitates acquiring and monitoring location data (e.g., determine a location of the golf ball relative to a golf cart). The course sensors 220 may communicate directly with the vehicles 10, directly with the remote systems 240, and/or indirectly with the remote systems 240 (e.g., through the vehicles 10 or the golf balls 150 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons breaking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). As shown in FIG. 4, the user portal 230 is accessible via the user device 232. The user device 232 may be or include a computer, laptop, smartphone, tablet, or the like. The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230.

As shown in FIG. 4, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 4, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the course sensors 220 via the communications network 210. By way of example, the remote systems 240 may receive the vehicle data from the vehicles 10 and/or the operator data from the course sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the course sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle control systems 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Golf Ball Tracking

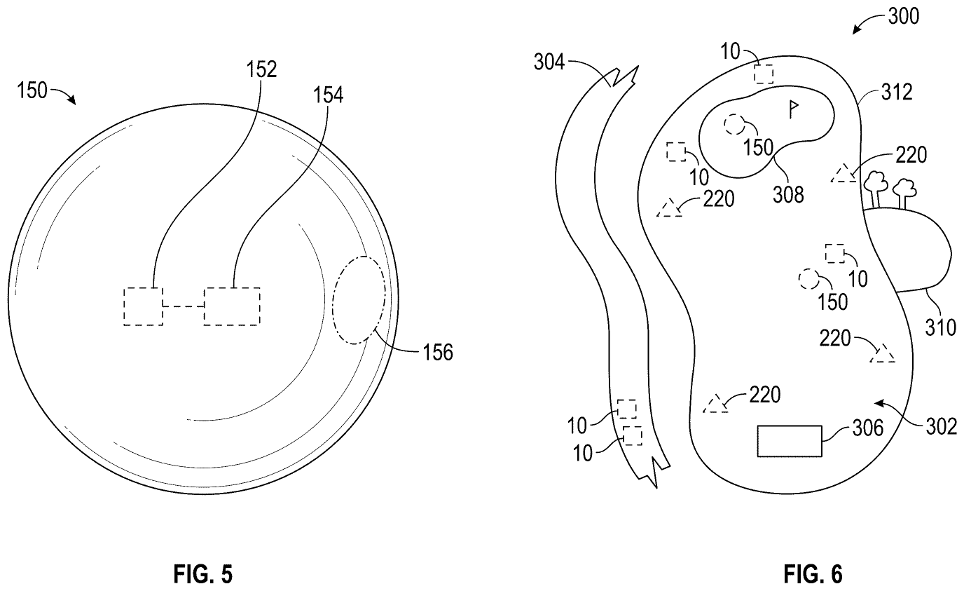

As shown in FIG. 5, the golf ball 150 includes one or more first sensors (e.g., BLE, GPS, cellular, active sensors, powered sensors, etc.), shown as first communication device 152; one or more energy storage devices, shown as battery 154; and a second (e.g., NFC tags, RFID tags, UWB tags, passive sensors, non-internally-powered, etc.), shown as second communication devices 156. The golf ball 150 is configured to facilitate tracking and detecting the position of the golf ball 150.

In some embodiments, the first communication device 152 may be embedded within the golf ball 150. The first communication device 152 is configured to determine a location of the golf ball 150 in real time. For example, the first communication device 152 may be a GPS device, a cellular device, or a Bluetooth Low-Energy (BLE) device. In some embodiments, the first communication device 152 may continuously or substantially continuously (e.g., once every second or at a quicker frequency) obtain sensor data from the golf ball 150. The vehicle controller 100 and/or the remote systems 240 may be configured to receive the sensor data from the first communication device 152 (when in communication range therewith) and process the data continuously and in real time or substantially real time. For example, the vehicle controller 100 and/or the remote systems 240 may process the sensor data to determine, detect, and/or identify the location of the golf ball 150.

In some embodiments, the battery 154 is embedded within the golf ball 150. The battery 154 may store energy to power the system of the golf ball 150. The battery 154 may be electrically coupled to one or more components of the golf ball 150 (e.g., the first communication device 152, the second communication device 156, etc.) to supply the stored electrical energy. The ball charger 108 may wirelessly supply electrical energy to charge the battery 154 of the golf ball 150. The ball charger 108 may be configured to receive golf balls 150 (e.g., contain circular recesses). In other embodiments, the golf ball 150 is otherwise powered. By way of example, the golf ball 150 may include external contactors that engage with contactors of the ball charger 108 to the charge the golf ball 150. In some embodiments, the golf ball 150 does not include the battery 154. In such embodiments, the golf ball 150 may not include the first communication device 152.

In some embodiments, the second communication device 156 is on the surface of the golf ball 150 (e.g., a sticker). The second communication device 156 is configured to establish communications with the sensors 90 and/or the course sensors 220 (e.g., when the sensors are configured to read or detect RFID tags, NFC tags, BLE enabled tags, UWB tags, etc.) when the golf ball 150 is hit or otherwise within a communication range of the sensors 90 and/or the course sensors 220 and, responsive to the communications being established between the sensors 90 and/or the course sensors 220 and the second communication device 156, the vehicle controller 100 and/or the remote systems 240 determine the presence and location of the golf ball 150. The vehicle controller 100 and/or the remote systems 240 are configured to determine a detected location of the golf ball 150 relative to the sensors 90 and/or the course sensors 220 and/or the drivable areas. The detected location of the golf ball 150 relative to the sensors 90 and/or the course sensors 220 and/or the drivable areas may include a position (e.g., a distance) and an orientation (e.g., a heading, an angle, a pose, etc.) of the golf ball 150 relative to the vehicle 10 and/or course sensors 220.

In various embodiments, location data of the golf ball 150 is displayed to the golfer via the user portal 230 and/or on the operator interface 48 of the vehicle 10. The location data may be acquired based on communications between (a) the first communication device 152 and/or the second communication device 156 and (b) the sensors 90 and/or the course sensors 220. The location data may be updated in real-time or substantially real time as the golfer makes shots during a round of golf.

As shown in FIG. 6, a golf ball detection system, shown as golf course system 300, includes a golf course 312, the site monitoring and control system 200 (e.g., the vehicles 10, the golf balls 150, the course sensors 220, etc.), a fairway 302, a path, a trail, a cart route, etc., shown as cart path 304, a tee box 306, a putting green, shown as green 308, and a water hazard, woods, fescue, etc., shown as the out-of-bounds area 310. The vehicles 10 may be golf carts driven by golfers playing golf on the golf course 312. In some embodiments, the vehicles 10 include a drink cart, a cart driven by an employee of the golf course 312 monitoring the pace of play of golfers, a cart driven by the maintenance crew working at the golf course 312, or another type of vehicle or vehicle commonly found at golf courses (e.g., a turf mower, a sprayer, an aerator, a bunker rake, etc.). A hole of the golf course 312 is shown including the tee box 306, the fairway 302, the out-of-bounds area 310, the green 308, and the cart path 304.

As shown in FIG. 6, the course sensors 220 are positioned throughout the golf course 312. The course sensors 220 are configured to facilitate communication with or between (e.g., transmit one or more signals with or between) the vehicle 10, the first communication device 152 of the golf ball 150, the second communication device 156 of the golf ball 150, and/or the remote systems 240. The course sensors 220 may be positioned throughout the golf course 312 such that the course sensors 220 detect the golf balls 150 and/or the vehicles 10 as the golf balls 150 and/or the vehicles 10 comes into range of the course sensors 220 (e.g., during a round being played by a golfer, after a golf stroke by a golfer, etc.). By way of example, the course sensors 220 may be positioned along the cart path 304, the fairway 302, etc., coupled to, a sign (e.g., a sign identifying the hole, a sign identifying yardage, etc.), coupled toa post or railing of a bridge on the golf course 312, coupled to a tree, and/or otherwise positioned along the golf course 312 where the vehicles 10 are configured to drive along (e.g., along the cart path 304, in a parking lot, in the fairway 302, over a bridge, etc.) or where the golf balls 150 may be hit.

In some embodiments, the vehicles 10 and the sensors 90 thereof form a sensor or mesh network that can be used in combination with or separate from the course sensors 220 to track the actual or real-time locations of the golf balls 150 (e.g., without requiring GPS or power on the golf balls 150).

In some embodiments, the golf course system 300 (e.g., the vehicle control system 100, the remote systems 240, etc.) is configured to determine an estimation of where the golf ball 150 is located on the golf course 312 (e.g., after a golf stroke). The estimation includes a distance and direction of the golf ball 150 relative to the vehicle 10. The estimation may be used to facilitate determining where the golf ball 150 is located. For example, the estimation may be used in combination with the sensor data from the golf ball 150 to identify the location of a golf ball 150. The estimation may be based on player profiles and player history (e.g., accessing shot history to make a better estimate for where the golf ball 150 lands after a golf stroke). In some embodiments, the golf course system 300 includes any component (e.g., device, element, or hardware) designed or configured to capture and store a history of shots and golf ball positions, including a memory or other storage device and/or one or more processors to store previously determined golf ball position and shot estimations. The component may be communicably coupled to the vehicle controller 100 and/or the remote systems 240. In some embodiments, the estimation and the history of shots and golf ball positions may be displayed to the golfer via the user portal 230 and/or the operator interface 48, and may be updated in real-time or substantially real time.

According to an exemplary embodiment, the golf course system 300 is configured to determine if a location of the golf ball 150 is (i) in a drivable area, (ii) near a geofence (e.g., within 5 yards of the geofence, within 10 yards of the geofence, etc.), or (iii) in a restricted area defined by the geofence. The course sensors 220 and/or the sensors 90 detect the golf ball 150 and transmit location data to the vehicle controller 100 and/or the remote systems 240 to be analyzed thereby to detect the drivable areas and the restricted areas. In some embodiments, whether the golf ball 150 is in a drivable area, near a geofence, or in a restricted area may be displayed to the golfer via the user portal 230 and/or the operator interface 48, and updated in real-time or substantially real time as the golf ball 150 moves throughout the golf course 312.

In some embodiments, the golf course system 300 provides recommendations to a golfer. For example, the recommendations may include a golf club suggestion, a shot suggestion, a tee positioning suggestion, etc. The recommendations may be based on a location of the golf ball 150 and/or based on player profiles and player history. In some embodiments, the recommendations may be displayed to the golfer via the user portal 230 and/or the operator interface 48, and updated in real-time or substantially real time.

In some embodiments, the golf course system 300 calculates shot parameters of the golf ball 150 responsive to a golfer hitting the golf ball (e.g., a golf stroke). The shot parameters may include ball spin, ball speed, distance, trajectory, etc. During a golf stroke, one or more signals may be received from the one or more sensors (e.g., of the golf ball 150, of the course sensors 220, of sensors 90). The one or more signals may be transmitted to the vehicle controller 100 and/or the remote systems 240. The vehicle controller 100 and/or the remote systems 240 calculate the shot parameters. In some embodiments, the shot parameters may be displayed to the golfer via the user portal 230 and/or the operator interface 48, and updated in real-time or substantially real time throughout the trajectory of the golf ball 150 and/or following the shot. For example, the golfer may see, on the user portal 230 and/or the operator interface 48, the speed, altitude, flight path, and/or spin rate of the golf ball 150 throughout the trajectory of the golf ball 150. In another example, the one or more sensors may track the trajectory of the golf ball 150 for a portion of a flight path of the golf ball 150 (e.g., live tracking) and estimate the remaining portion of the flight path based on the initial tracking.

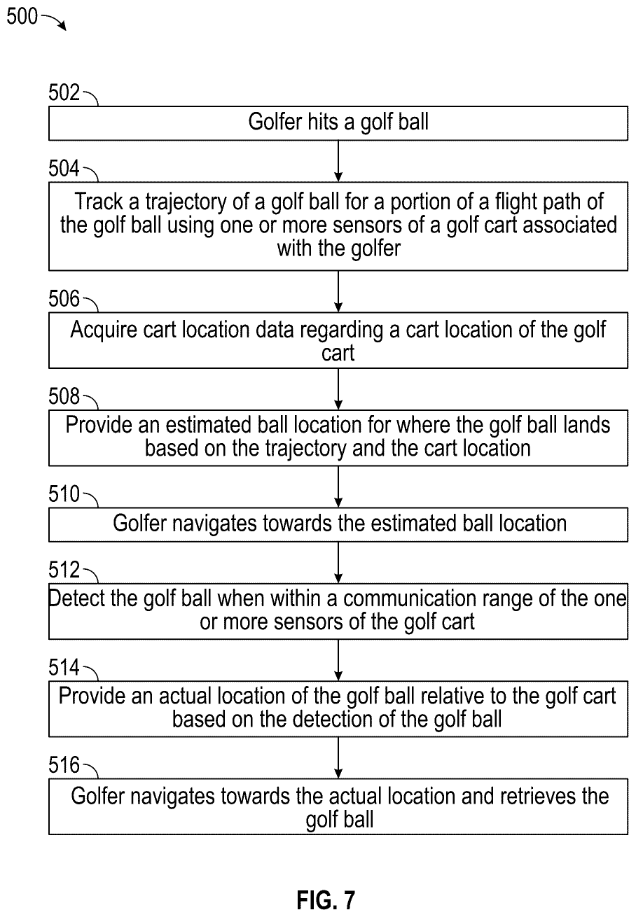

Referring now to FIG. 7, a block diagram for a method 500 for providing a location of the golf ball is shown, according to an exemplary embodiment. One or more golfers may be on the golf course 312 to play a round of golf with one or more golf balls 150. The method 500 may be executed by a first processing circuit located on the golf cart and/or a second processing circuit located remote from the golf cart (e.g., the remote systems 240).

At step 502, a golfer hits a golf ball (e.g., the golf ball 150, a golf stroke) on a golf course (e.g., the golf course 312). For example, the golf ball may be positioned on a tee in a tee box of a hole where the golfer hits the golf ball off a tee indicating that a golfer has attempted to hit the golf ball toward the corresponding green.

At step 504, one or more processing circuits (e.g., of the vehicle controller 100, of the remote systems 240, of the golf ball 150, etc.) track a trajectory of the golf stroke for a portion of a flight path of the golf ball. For example, the one or more processing circuits may determine based on one or more signals from one or more sensors a trajectory of the golf ball. The trajectory may include a position, a speed, a direction, an acceleration, a spin, an altitude, etc. of the golf ball.

At step 506, the one or more processing circuits acquire location data regarding a cart location of the golf cart and/or the golfer. For example, the one or more processing circuits may determine, based on the one or more signals from the one or more sensors, a current location of the golf cart and/or the golfer. The current location of the golf cart and/or the golfer may be determined using a global positioning system (GPS) sensor (e.g., of the vehicle 10, of the user device 232, etc.) that facilitates determining the current location of the golf cart and/or the golfer.

At step 508, the one or more processing circuits provide an estimated location for where the golf ball lands. For example, the one or more processing circuits may determine, based on the trajectory, the golfer location, and/or the cart location, an estimated location for where the golf ball lands. In another example, the one or more processing circuits may determine, based on the one or more signals from the one or more sensors, an estimated location of the golf ball relative to one or more golf balls on the golf course. The estimated location of the golf cart may be determined using one or more identifiers that facilitates determining the current location of the golf cart.

At step 510, the golfer navigates towards the estimated position of the golf ball. For example, responsive to the golfer receiving the estimated position of the golf ball, the golfer may drive the golf cart towards the estimated position of the golf ball.

At step 512, the one or more processing circuits detect the golf ball responsive to the golf ball being within a communication range of the one or more sensors (e.g., the sensors 90) of the golf cart. For example, responsive to the golf cart being in range of the golf ball, a communication device thereof (e.g., RFID, BLE, NFC, UWB, the second communication device 156, etc.) may facilitate communication with or between (e.g., transmit one or more signals with or between) the sensors of the golf cart. As another example, responsive to a user device (e.g., the user device 232) carried by the golfer being in range of the golf ball, a communication device thereof (e.g., RFID, BLE, NFC, UWB, the second communication device 156, etc.) may facilitate communication with or between (e.g., transmit one or more signals with or between) the user device.

At step 514, the one or more processing circuits provides an actual location of the golf ball relative to the golf cart (e.g., via the user portal 230, on the user device 232, on the operator interface 48, etc.). For example, the one or more processing circuits, based on the detection of the golf ball, may determine the actual location of the golf ball.

At step 516, the golfer navigates towards the actual location of the golf ball. For example, responsive to a golf stroke, the golf ball may be positioned on the green of the hole. The golfer may drive the golf cart to the actual location of the golf ball and retrieve the golf ball or set up to hit the golf ball for a subsequent stroke.

In various embodiments, the golf stroke is a first golf stroke, the estimated position is a first estimated position, and the actual location is a first actual location on a respective hole. As such, the method 500 includes determining that the golfer has located the golf ball and then a second golf stroke of the golfer has occurred on the respective hole, determining a second estimated position of the golf ball after the second golf stroke and determining a second actual position of the golf ball using the same method as method 500. In various embodiments, the method 500 may include displaying, on a user interface (e.g., the operator interface 48, the user device 232, etc.), the trajectory, the flight path, the cart location, the estimated position, and/or the actual location of the golf ball.

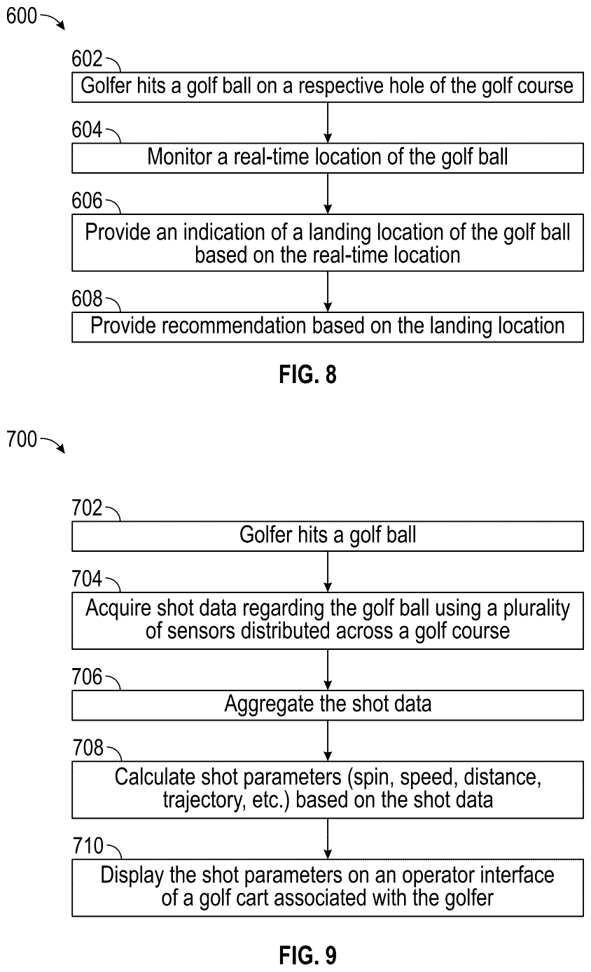

Referring now to FIG. 8, a block diagram for a method 600 for real-time tracking of the golf ball 150 is shown, according to an exemplary embodiment. One or more golfers may be on the golf course 312 to play a round of golf with one or more golf balls 150. The method 600 may be executed by a first processing circuit located on the golf cart and/or a second processing circuit located remote from the golf cart (e.g., the remote systems 240).

At step 602, a golfer hits a golf ball (e.g., golf stroke) on the golf course. For example, the golf ball may be positioned on a tee in a tee box of a hole where the golfer hits the golf ball off a tee indicating that a golfer has attempted to hit the golf ball toward the corresponding green.

At step 604, one or more processing circuits monitor a real-time location of the golf ball. For example, the real-time location may be determined based on location data collected by the sensors of the golf ball (e.g., the first communication device 152, second communication device 156), sensors of one or more golf carts or other vehicles on the course (e.g., the sensors 90), and/or sensors of the golf course (e.g., the course sensors 220). The location data may include GPS, UWB, BLE, RFID, NFC, and/or other types of location data.

At step 606, the one or more processing circuits provide an indication of a landing location of the golf ball. For example, the one or more processing circuits, based on the real-time location, may determine if a landing location of the golf ball is (i) in a drivable area, (ii) near a geofence (e.g., within 5 yards of the geofence, within 10 yards of the geofence, etc.), or (iii) in a restricted area defined by the geofence.

At step 608, the one or more processing circuits provide a recommendation to the golfer. For example, based on the landing location of the golf ball, the one or more processing circuits may display a recommendation to the golfer on a user portal. Responsive to a determination that the golf ball 150 is near or in the geofence, based on the landing location of the golf ball, the user portal may display a warning indicating to the user of the restricted position. For example, the warning may include a distance indicating how far the golf ball has traveled in the geofence, and/or a time indicating how long the golf ball has been in the geofence. The parameters for triggering such warning may be set using the user portal. The warning may act as a recommendation for the golfer to not retrieve the golf ball from the landing location. Responsive to a determination that the golf ball is not in a restricted area, based on the landing location of the golf ball, the user portal may display a green light (e.g., go ahead, proceed, continue, drive, etc.) indicating to the golfer that the golf ball is in a drivable area. The green light may act as a recommendation for the golfer to retrieve the golf ball from the landing location. Additionally, the one or more processing circuits may provide a recommendation to the golfer (e.g., a golf club suggestion, a shot suggestion, a tee positioning suggestion, etc.). For example, based on the landing location of the golf ball 150, the one or more processing circuits may provide a shot suggestion to advance the golfer throughout the hole. In some embodiments, the recommendation is a suggested travel path to the real-time location or an indication of the real-time location so that the golfer can efficiently navigate to the golf ball.

In various embodiments, the golf stroke is a first golf stroke, the real-time location is a first real-time location, and the landing location is a first landing location on a respective hole. As such, the method 600 includes determining that the golfer has located the golf ball and then a second golf stroke of the golfer has occurred on the respective hole, determining a second real-time location of the golf ball after the second golf stroke and determining a second landing location of the golf ball using the same method as method 600. In various embodiments, the method 600 may include displaying, on a user interface, the real-time location, the landing location, the flight path, and the cart location.

Referring now to FIG. 9, a block diagram for a method 700 for calculating shot parameters is shown, according to an exemplary embodiment. One or more golfers may be on the golf course 312 to play a round of golf with one or more golf balls 150. The method 700 may be executed by a first processing circuit located on the golf cart and/or a second processing circuit located remote from the golf cart (e.g., the remote systems 240).

At step 702, a golfer hits a golf ball (e.g., golf stroke) on the golf course. For example, the golf ball may be positioned on a tee in a tee box of a hole where the golfer hits the golf ball off a tee indicating that a golfer has attempted to hit the golf ball toward a corresponding green.

At step 704, one or more processing circuits acquire shot data based on one or more signals from a plurality of sensors (e.g., from the golf cart 10, about the golf course 312, on other vehicles, etc.) distributed across the gold course. For example, the one or more processing circuits may acquire data in real-time during a golf stroke and may continue acquiring data in real-time after the golf stroke.

At step 706, the one or more processing circuits aggregate the shot data. For example, the one or more processing circuits may process or combine data from the one or more signals from the plurality of sensors.

At step 708, the one or more processing circuits calculate shot parameters (e.g., spin, speed, distance, trajectory, landing location, altitude, final location following a bounce, etc.) based on the shot data. For example, a spin of the golf ball, an angle of the golf ball, a speed of the golf ball, a distance the golf ball travels, a trajectory of the golf ball, etc. may be calculated responsive to the golf ball 150 being hit.

At step 710, the one or more processing circuits display the shot parameters (e.g., spin, speed, angle, distance, trajectory, etc.) on a display device associated with the golfer. For example, the golfer may be located in the golf cart responsive to the golf stroke and may see the shot parameters of the golf stroke on a display device located in the golf cart.

In various embodiments, the golf stroke is a first golf stroke, and the shot parameters are a first shot parameters. As such, the method 700 includes determining that the golfer has located the golf ball and then a second golf stroke of the golfer has occurred on the respective hole, determining a second shot parameters of the golf ball after the second golf stroke using the same method as method 700.

As utilized herein with respect to numerical ranges, the terms “approximately,” “about,” “substantially,” and similar terms generally mean+/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.) and the site monitoring and control system 200 (e.g., the remote systems 240, the user portal 230, the course sensors 220, etc.) as shown in the various exemplary embodiments is illustrative only. Additionally, any element disclosed in one embodiment may be incorporated or utilized with any other embodiment disclosed herein.

1. A golf course system comprising:
one or more processing circuits configured to:
acquire one or more signals from a communication device of a golf ball; and
provide an indication on a display device associated with a golfer regarding a position of the golf ball on a respective hole of a golf course following a golf stroke of the golfer based on the one or more signals.

2. The golf course system of claim 1, wherein the communication device is embedded in the golf ball.

3. The golf course system of claim 1, wherein the communication device is disposed along an exterior surface of the golf ball.

4. The golf course system of claim 1, wherein the communication device includes a GPS device or a cellular device.

5. The golf course system of claim 1, wherein the communication device includes at least one of (a) radio frequency identification device, (b) a near field communication device, or (c) a Bluetooth Low-Energy device.

6. The golf course system of claim 1, wherein the display device is integrated into a golf cart associated with the golfer.

7. The golf course system of claim 1, wherein the display device is portable.

8. The golf course system of claim 1, further comprising a golf cart including a charging interface configured to charge a battery of the golf ball.

9. The golf course system of claim 1, further comprising the golf ball, the golf ball including the communication device.

10. The golf course system of claim 9, wherein the golf ball includes a battery.

11. The golf course system of claim 1, wherein the one or more processing circuits are configured to provide a recommendation via the display device based on the position of the golf ball.

12. The golf course system of claim 11, wherein the one or more processing circuits are configured to determine if the golf ball is in a restricted area or out of bounds, and wherein the recommendation includes an instruction to not retrieve the golf ball.

13. The golf course system of claim 11, wherein the recommendation includes at least one of a club suggestion or a shot suggestion.

14. The golf course system of claim 1, further comprising one or more sensors configured to acquire the one or more signals.

15. The golf course system of claim 14, wherein the one or more sensors are configured to be installed at least one of (a) on a golf cart associated with the golfer, (b) about the golf course, or (c) on other vehicles on the golf course.

16. The golf course system of claim 15, wherein the one or more sensors are configured to be installed on the golf cart, and wherein the one or more processing circuits are configured to:
track a trajectory of the golf ball for a portion of a flight path of the golf ball based on the one or more sensors;
acquire cart location data regarding a cart location of the golf cart;
provide an estimated ball location for where the golf ball lands, based on the trajectory and the cart location data;
detect the golf ball when within a communication range of the one or more sensors; and
provide an actual location of the golf ball relative to the golf cart based on a detection of the golf ball.

17. The golf course system of claim 15, wherein the one or more sensors are configured to be installed on two of more of (a) the golf cart, (b) about the golf course, or (c) on the other vehicles, and wherein the one or more processing circuits are configured to:
acquire shot data regarding the golf ball based on the one or more sensors;
aggregate the shot data;
calculate shot parameters based on the shot data; and
display the shot parameters on the display device.

18. The golf course system of claim 1, wherein the one or more processing circuits include at least one of (a) a first processing circuit configured to be located on a golf cart associated with the golfer or (b) a second processing circuits located remote from the golf cart.

19. A golf course system comprising:
a golf ball including a communication device;
a golf cart including one or more sensors configured to acquire one or more signals from the communication device of the golf ball; and
one of more processing circuits configured to:
track a trajectory of the golf ball for a portion of a flight path of the golf ball based on the one or more sensors;
acquire cart location data regarding a cart location of the golf cart;
provide an estimated ball location for where the golf ball lands, based on the trajectory and the cart location data;
detect the golf ball when within a communication range of the one or more sensors; and
provide an actual location of the golf ball relative to the golf cart based on a detection of the golf ball.

20. A golf vehicle system comprising:
a plurality of sensors configured to acquire signals from communication devices of golf balls on a golf course, the plurality of sensors configured to be installed at least one of (a) on golf carts or (b) about the golf course;
one of more processing circuits configured to:
acquire shot data regarding the golf ball based on the one or more sensors;
aggregate the shot data;
calculate shot parameters based on the shot data; and
display the shot parameters on the display device.
